(19) United States
(12) Patent Application Publication
(10) Pub. No.: US 2008/0148059 A1
(43) Pub. Date: Jun. 19, 2008

(54) Universal, Biometric, Self-Authenticating Identity Computer Having Multiple Communication Ports

(76) Inventor: Michael F. Shapiro, Tampa, FL (US)

Correspondence Address: HORNKOHL INTELLECTUAL PROPERTY LAW, P.L.L.C, P.O. BOX 210584, NASHVILLE, TN, 37221, US

(21) Appl. No.: 12/036,218

(22) Filed: Feb. 22, 2008

Related U.S. Application Data
(63) Continuation-in-part of application No. 10/628,282, filed on Jul. 25, 2003.

(51) Int. Cl. H04L 9/32

(52) U.S. Cl. 713/186

(57) ABSTRACT

An improved device for use in authorizing transactions, supplying information and performing applications is provided by the present invention, effectively implementing a secured individual and portable Public Key Infrastructure (PKI) terminal. The device uses a local processor and secure data storage in conjunction with a variety of sensors to perform authentication processes that establish an individuals identity and provide authority to perform a desired transaction. The sensors allow the device to directly scan biometric identifying information from an individual. A card swipe interface and a proximity antenna are provided to facilitate communication between the device and remote interface devices such as magnetic swipe card readers, smart card readers, infrared communications ports and proximity and long range radio scanners. In addition, the local processor, memory, display and user inputs allow the device to run applications such as those performed by a traditional computer, gaming device, personal data assistant and smart phone.

This application is a Continuation-In-Part application which claims benefit of co-pending U.S. patent application Ser. No. 10/628,282 fled Jul. 25, 2003, entitled “Universal, Biometric, Self-Authenticating Identity Computer Having Multiple Communication Ports” which is hereby incorporated by reference.

### FIELD OF THE INVENTION

The present invention relates generally to the field of smart identification systems and personal identification verification. More particularly, the present invention relates to a smart identification device that uses biometric sensors, in conjunction with independent on-device processing, memory, communications ports and power, as well as a certificate authority scheme and a back-end certificate server, to provide a personalized, self-authenticating, self-contained, multiple purpose, identification, application computer and secure electronic credential and data container enabling the functionality of a personal portable public key infrastructure (PKI) terminal.

### BACKGROUND

Identification cards are widely used to establish an individual's identity and thus, allow the individual to access a particular type of account or service. Typically, the identification card consists of a picture and a set of data associated with the pictured individual. To make an identification, an authority figure reviews the image and data on the identification card and makes the identification decision based upon their visual observations. However, this type of identification suffers from a number of well-known drawbacks. For example, images are easily produced using modern copiers and color printers, and a fake visual form of identification can inexpensively be produced. Furthermore, the actual affirmative identification most often depends upon the judgment and competence of the individual making the visual comparison. Therefore, such an identification system is never more reliable than the least reliable individual administering the system. Moreover, updating the information contained on such a card typically requires producing a new card and obtaining the individual's consent to the update. Finally, as additional needs for identification cards arise and as cards are used in additional venues, it is a significant advantage if the credential system maintains security but can be easily updated and adapted for multiple uses and for use by multiple organizations without radical overhaul.

Personal data assistants (PDAs) and smart phones are computer-controlled devices that let individuals run various applications and communicate via mobile or cellular networks. These applications often include calculators, e-mail, daily planners, alarms, games, etc. Although PDAs are popular, widely used devices and smart phones are becoming more widely used, they are unable to perform truly secure transactions or affirmatively identify their users and the entities with which they may interact. In addition, PDA's and smart phones are not equipped to communicate easily with devices such as credit card machines, magnetic swipe card readers, smart card readers, proximity detectors, etc.

The widespread use of magnetic stripe cards calls for a means to both secure the information contained on the magnetic stripe as well as provide for dynamically loading information onto the magnetic stripe appropriate for the intended use and make it available only for the duration of the transaction so that a single device would satisfy the plethora of applications for which magnetic stripe cards are used while maximizing security. Moreover, existing magnetic stripes are limited in the amount of information they can contain, precluding the inclusion of encryption or validation codes and keys as well as other information that would improve security and enhance usefulness.

Convergence between data processing and communications is an emerging technology trend. There is an increasing demand for consolidation among the devices that are carried by an individual, particularly mobile communications (cellular telephony), as well as a need to secure these communications as well as provide validation of the individual user before he or she gains access to the communications services in the first place.

In a digital world of electronic transactions, neither party really knows the other, the exact route the transaction may follow—or any intermediate stops—and must have some way of safeguarding the information and the transaction. Since transactions may take place between any number of parties in no pre-defined manner, there must be a way to provide identification and security for a large volume of transactions. This is the role of what is called a Public Key Infrastructure or PKI.

The value of PKI rests on its integrity and maintaining the “chain of trust” between individuals, certificates and certificate authorities, in which any break can compromise PKI security and transactions. Layered certificates in the form of manufacturer's certificates combined with issuance certificates from each participating organization enhance security in a multi-party environment so that compromise of any single participating organization will not affect any other organization or provide a means to penetrate the security of the entire system.

The most often cited shortcomings in PKI are the vulnerability of the private key, which is the basis of the PKI key pair, and not tying the individual to the digital certificate (or signature).

Smart cards have assumed the role of secured information container in identification and other uses. However, as unpowered devices they must rely on the strength of their encryption algorithms as a passive means to maintain their integrity. Smart cards have been found vulnerable to a number of different physical and non-invasive “attacks” that have been reported by researchers in the US and Europe.

In light of the above discussed deficiencies in the prior art, what is needed is an improved form of personal identification, credentialing and portable data storage that is difficult to counterfeit, maintains the integrity of stored and transmitted information, blunts the effectiveness of attempts to break in and steal its data, communicates with other electronic devices, provides a evolvable operational framework that is easy to update as new needs, uses and technologies arise, is part of a comprehensive Public Key Infrastructure architecture and is self-authenticating.

### SUMMARY OF THE INVENTION

A preferred embodiment of the present invention is directed toward a portable, hand-held device for authenticating an individual's identity and authorizing physical access or use of limited access accounts and services, as well as transmitting and receiving information stored on the device. The portable device includes emulation of a magnetic stripe that is readable by a standard swipe card reader and a power supply for providing power to the device. Means for writing to a magnetic strip emulator are provided that allow a processor to generate information and a magnetic signal to emulate what would ordinarily be contained on and readable from a magnetic stripe. A keyboard allows the entry of commands or text into the device. Input communication means receive configuration information, commands and a request for an authentication signal from a remote source. In response to the received request for an authentication signal or a manual activation by a user, a biometric sensor scans and detects biometric information and produces a sensed biometric profile as well as allowing the portable device to store in memory the raw biometric image that is first captured by the sensor. A biometric profile corresponding to an individual is contained in a memory on the portable device. The memory also contains encrypted certification information that can be examined by a remote source or passed to a certificate server to determine if the device corresponds to an authorized account. The processor compares the sensed biometric profile with the registered and stored biometric profile and produces an authentication signal, certificate or message. In a preferred embodiment, the biometric sensor is a fingerprint detector and the processor and memory include fingerprint recognition software for determining if one or more sensed fingerprint(s) match(es) a registered and stored profile. In alternative embodiments using a variety or combination of biometric sensors, the biometric sensor may be a microphone that receives audible signals and voice recognition software that compares the audible signals with registered and stored individual audio profiles or a camera that captures an image of the user's iris or facial geometry and comparison software that matches the images with registered and stored profiles of the individual. Output communication means communicate the authentication signal to the remote source. In a most preferred embodiment, the output communication means is one or more radio frequency transceiver(s) and antenna(e) for sending and receiving messages from a radio frequency transceiver reader. However, in alternative embodiments, the output communication means could include an infrared communication port, a serial or USB communication port, smart card contacts or other wired or wireless communication channels. A speaker is also provided that allows the processor to produce audible indications and outputs.

The present invention includes the creation of an audit log of authentications that are used for security comparison purposes and can additionally be matched to information recorded by other systems to transactions conducted with those other systems to prevent tampering and fraud. In addition, making a credential self-powered and adding a self-destruct mechanism cuts off the effectiveness of a wide variety of attacks because when someone tries to break into the device, the device can clear its memory so that no useful information remains. Furthermore, managing the device's operations under stored program control as opposed to “hard-wiring” the device allows it to assume additional functions as needs change and to incorporate new developments in applications and encryption methods.

The present invention also includes software programs running on one or more computers that provide security services as well as interfaces to the device for initial enrollment of the user and the creation, deposit and maintenance of encrypted security certificates and encryption keys on the device. The present invention's security services also can support the creating and handling of the certificate chains required for S/MIME, SSL, and other applications, and the creation of certificate revocation lists.

The present invention also includes an end-to-end certificate architecture that supports interoperability with any other validated or “trusted” Certificate Authority hierarchy and manages the issuance of the portable device to individuals, their enrollment on the device and control and maintenance of the certificates deposited on the device.

The present invention also includes programming to allow selected stored data or sets of data to become accessible to authorized parties, creating an audit log entry in the process, should the user be unconscious or otherwise unable or unwilling to utilize the device. This can be potentially life-saving as a means to provide physicians and other authorized personnel medical information about an injured patient or to provide tracking and locating information for an incapacitated person. The preferred embodiment of this feature requires two or more authorized parties to exercise a dual or multiple key access from after properly authenticating on their own devices. The present invention also includes programming to require taco or more authorized parties to exercise a dual or multiple key access after properly authenticating on their own portable devices and then creating the dual or multiple key before transmitting it to the r emote source. Creating a complete and accessible audit log guards against abuse.

Another embodiment of the present invention is directed toward a method of electronic data storage and processing. A display and keyboard communicate with a user of the invention when used as an electronic data assistant. The electronic data assistant also includes an internal memory that can be modified by the processor and a read-only memory that cannot be modified by the processor. Applications such as games, calculators, calendars, e-mail are stored in the memory and run by the processor. A data input allows the electronic data assistant to receive personal identifying data or commands from a remote source. In one embodiment, the data input is a fingerprint sensor that produces a fingerprint profile as personal identifying data in response to an individual placing their finger against the fingerprint sensor. In another embodiment, the data input is a microphone that produces an electronic data signal in response to received audio signals and voice recognition software processes the electronic data signal to produce the personal identifying data. The memory stores personal identification information related to a particular individual and the processor compares the personal identifying data to the stored personal identification information. An authentication signal is produced based upon the comparison. A data output communicates the authentication signal to a remote source. The output communication means is a card swipe interface that allows stored data to be communicated to a magnetic stripe card reader. In alternative embodiments, the output communications could include a smart card reader or one or more radio frequency transceiver(s) and antenna(e) for sending and receiving messages from a radio frequency transceiver reader. The output communication means can also include an infrared communication port, a serial or USB communication port, or other wired or wireless communication channels. A speaker is also provided that allows the processor to produce audible indications and outputs.

In alternate embodiments, the device could include, in addition to any other radio frequency capabilities, output communications via a cellular telephone providing both voice and data capabilities, so that authorizations or data exchanges can be undertaken from any location within the range of a cellular telephone network, and communications can take place with authentication of the individual initiating them. In accordance with this method, the device can also provide encryption to secure the communications.

Yet another embodiment of the present invention is directed toward a method of securing a vehicle, equipment, storage container or other inanimate object or system. The portable device is paired with one or more remote “slave” variants, with the several security features and one or more communications features, that can be used to secure the protected vehicle, equipment, storage container or other inanimate object or system. The remote slave or slaves may also be registered with additional “master” devices, set to respond only when a defined set of master devices transmit an authorization signal, and so on. In accordance with this method, the master-slave pair secures the inanimate object, provides status or location information and provides secured information with the same biometric authentication safeguards, via the paired master or masters, as if an individual remained in control of it.

Yet another embodiment of the present invention is directed toward a method of authorizing an individual to access an account or perform a transaction with a portable, hand-held electronic device. In accordance with the method, a communication center's request for an identification is detected with the portable device. A user of the hand-held electronic device is then prompted to respond to the request for an identification by providing biometric information such as a fingerprint or voice sample to the portable device. The user may also initiate the transaction by providing the biometric information to prepare the device for the transaction. The biometric information is received from the user with the hand-held electronic device. The biometric information is then processed with the hand-held electronic device to determine if the biometric information corresponds to an individual biometric profile registered and stored in the portable device. An authentication signal is produced with the hand-held electronic device and the authentication signal is communicated from the hand-held electronic device to the communication center in response to receiving the request for identification or, in the case that the user initiates the authorization transaction, when the communications center is ready to execute the transaction.

Yet another embodiment of the device is directed towards use within public key infrastructure (PKI) systems by providing a container to securely store digital signatures and encryption keys. The device can include a client implementation of any number of certificate session types formats and protocols, tying one or more keys or a certificate store to the session. In this manner, the device provides portable, secure and personal plug-and-play PKI, SSL and similar services. In accordance with the method, a PKI system request for an identification is detected with the portable device. A user of the hand-held electronic device is then prompted to respond to the request for an identification by providing biometric information such as a fingerprint or voice sample to the portable device. The user may also initiate the transaction by providing the biometric information to prepare the device for the transaction. The biometric information is received from the user with the hand-held electronic device. The biometric information is then processed with the hand-held electronic device to determine if the biometric information corresponds to an individual biometric profile registered and stored in the portable device. The device will then provide the necessary keys and validations to complete the PKI transaction. Introducing a portable certificate container and using it as the basis for all PKI transactions, in essence verifying the identities of both the originator and recipient of a transaction, the validity of the PKI transaction between the parties and the PKI structure itself can be assured.

An embodiment of the invention may include a global positioning receiver (GPS) that can provide the geographic location of the user at any given time. In such an embodiment, a communication center's request for an identification is detected with the portable device. A user of the hand-held electronic device is then prompted to respond to the request for an identification by providing biometric information such as a fingerprint or voice sample to the portable device. The user may also initiate the transaction by providing the biometric information to prepare the device for the transaction. The biometric information is received from the user with the hand-held electronic device. The biometric information is then processed with the hand-held electronic device to determine if the biometric information corresponds to an individual biometric profile registered and stored in the portable device. The device will then provide the location of the user at the time of authentication to the communications center or other required system.

Yet another embodiment of the invention is directed toward a device for use with an existing magnetic card or smart card readers. The device includes a removable card, similar in size and shape to a credit card, that can be docked with it. On this card is included a power supply, a processor, memory, a magnetic stripe emulator that is readable by a standard swipe card reader with writing means that allow the processor to alter information contained on the magnetic stripe emulator, smart card contacts, indicator lights or display and contacts to provide communications with the device. Once authenticated to the device as discussed above, the user can choose to load the docked removable card with identifying information or other data, remove the card from the device, and use it in a magnetic stripe or smart card reader, such as a banking ATM, where it can be used in a manner that is indistinguishable from the cards currently used with such equipment. The processor on the card can maintain security by clearing the information contained in the card's memory after a user-selected or programmed period of time that can correspond to the expected duration of use. After use, the card can be returned to its position docked with the device.

The above-discussed embodiments of the present invention provide a number of advantages over the prior art. By providing an on-device memory and processor, the invention allows credible identifications to be obtained without any reliance upon human judgment or integrity. In addition, the storing of the biometric profile information on the device itself restricts access to the personal information and eliminates the need to compile large databases of this personal information. It also does not require the creation of network facilities to store and carry the information, which transport, in itself, creates a security risk by exposing it to interception and hinders more widespread adoption by requiring an extensive supporting infrastructure. Registration certificates and segmented, limited access memory on the device also insure that the personal data registered and stored on the device is not modified by unauthorized users. Because it is self-powered and active, the device can incorporate various means to preclude tampering. Furthermore, the device can participate in bilateral authentication transactions to ensure that the parties and/or systems with which it is used are validated and authorized, to preclude spoofing and other attacks. The provision of the processor, display and data inputs on the portable device allow personal computing functions such as scheduling, calculating and running application software to be incorporated into the portable device. The ability to communicate with a variety of different types of devices in a variety of different formats increases the utility of the portable device by allowing it to perform a number functions typically performed by separate devices. Therefore, the present invention represents a substantial improvement upon the prior art.

### BRIEF DESCRIPTION OF THE DRAWINGS

FIG. 1 is a functional diagram of a preferred embodiment of the present invention;

FIG. 2 is a flow chart of a registration procedure utilized by a preferred embodiment of the present invention;

FIG. 3 is a flow chart of an authentication procedure utilized by a preferred embodiment of the present invention;

FIG. 4 is a flow chart of a transaction/application procedure utilized by a preferred embodiment of the present invention;

FIG. 5 is a pictorial representation of an external housing for an embodiment of the present invention;

FIG. 6 is a pictorial representation of an external housing for another embodiment of the present invention;

FIG. 7 is a pictorial representation of an external housing for an embodiment of the present invention;

FIG. 8 is a pictorial representation of a housing for a fingerprint sensor for an embodiment of the present invention; and

FIG. 9 is a flow chart of a locator procedure, via GPS or other means, utilized by a preferred embodiment of the present invention.

### DETAILED DESCRIPTION OF THE INVENTION

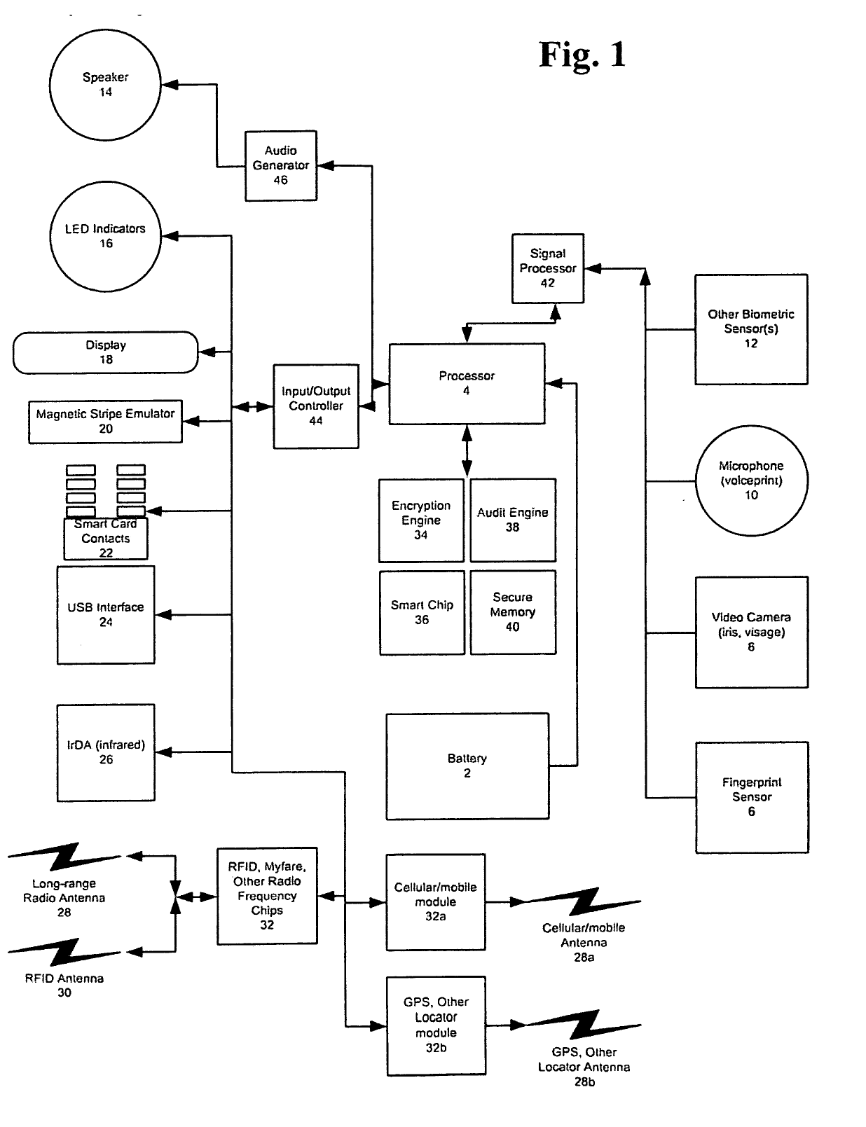

Referring now to FIG. 1, a functional diagram of the components of an identification device constructed in accordance with a preferred embodiment of the present invention is shown. The device includes a battery 2 that provides power to the electronics of the portable device. A microprocessor 4 is used to control the electronics and manage the functioning of the device. The microprocessor 4 communicates with a variety of biometric sensors 6, 8, 10 and 12 through a signal processing circuit 42. Although a wide variety of biometric sensors 12 may be used with the device of the present invention, the microprocessor 4 preferably relies upon a microphone 10, fingerprint sensor 6, and digital camera 8 to receive biometric information concerning an individual. The processor 4 also controls a number of input/output ports 14, 16, 18, 20, 22, 24, 26, 28 and 30. More particularly an audio generator 46 is used in conjunction with a speaker 14 to provide audible indications or instructions in the form of voice responses to a user of the device. An input/output controller 42 interfaces the processor 4 with a set of LED indicators 16 and a display 18 to provide visual indications and instructions to a user of the device. The input/output controller 42 also interfaces the processor 4 with a set of smart card contact points 22 that may be used to transfer information between the device and a smart card in accordance with standard smart card formatting. A standard USB interface 24 and infrared data port 26 allow the processor 4 to communicate with other devices having similar input/output ports. Finally, a long-range radio antenna 28 and a RFID proximity antenna 30 communicate with the processor 4 through an associated radio frequency chip 32 and the input/output controller 44. The processor 4 communicates internally with an encryption engine 34, an audit engine 38, a smart chip 36 and a secure memory 40. The encryption engine 34 encodes outgoing information and decodes incoming information to help prevent unauthorized access to restricted information. The secure memory 40 includes ROM memory that contains static information needed to operate the device and RAM that can store application software that can be run on the device.

The identification device is used by applying an input to one of the sensors 6, 8, 10 and 12. For example, a user can activate the device by placing a finger against the fingerprint sensor 6. The signal processor 42 and fingerprint sensor 6 detect the presence of the finger on the fingerprint sensor 6 and instruct the processor 4 to validate the sensor's 6 output. If the fingerprint sensor's 6 output corresponds to a fingerprint profile registered and stored in the secure memory 40, the processor 4 produces an authorized and/or authentication output that indicates that the appropriate individual has placed their finger on the fingerprint sensor 6. If the fingerprint sensor's 6 output does not correspond to an authorized profile, the processor 4 communicates an output that indicates the user has not been authorized by the device. Under stored program control or validated configuration information and commands from a validated remote source, the processor can also require the user to supply biometric samples in a certain order, such as thumb, ring finger, middle finger, or in a certain combination, such as thumb and voiceprint, before it will determine that the user has properly authenticated. The user can also designate a preselected biometric sample or sequence that is designated a “panic” signal that, when supplied by the user to authenticate on the portable device, indicates the user is acting under duress.

The processor 4 can communicate the results of the biometric identification with remote sources and stations, as well as raw scanned images when programmed for a specific and authorized application, through a number of communication outputs 14, 16, 18, 20, 22, 24, 26, 28 and 30. If used with a smart card reader, the processor 4 can transmit data to, and receive data from, the smart card reader through the smart card contact array 22 mounted on the device. When the contacts of the contact array 22 are electrically connected to the contacts of the smart card reader, the processor 4 can communicate with the smart card through the contacts 22 using established communication protocols stored in the smart chip 36. The speaker 14 and microphone 10 are used in conjunction with voice recognition software to receive voice commands from a user, communicate audible messages to the user and perform biometric identification processes. The infrared communication port 26 allows the processor 4 to communicate with personal data assistants, computers, printers, cameras and a plethora of additional electronic devices that utilize infrared communication channels.

In response to an affirmative biometric identification, the device may perform a number of authorization functions such as producing and communicating authentication signals, digital signatures or encrypted certificates. For example, an authorization code may be communicated from the device to an external machine such as a telephone, PDA or automated teller machine. The authorization code may be associated with an account or an individual such that the reception of the authorization code by the remote source accesses an account of the individual and allows the individual to debit or credit the account in conformance with a set of predetermined criteria. Alternatively, the authorization code may be used to establish a communication link with an outside device using the infrared communications port 26. For example, if a customer wanted to access their e-mail account through a remote source, the device can communicate the authorization code and the user's (account holder's) information to the remote source. The remote source can then access and/or debit an account associated with the device or individual based upon the device's identification of the user and allow the user to access their e-mail. Alternatively, the individual can access confidential information such as medical records and receive an authenticated prescription from a health care provider that would then be transferred to a pharmacist along with an authenticated certificate that would allow the pharmacist to fill the individual's prescription without a paper prescription.

A timing function may be implemented by the processor 4 such that the authorization obtained through a biometric identification, such as by placing a finger on the fingerprint sensor 6, only last a predetermined amount of time, such as five minutes. This timing function insures that the authorized individual is in possession of the device substantially contemporaneously with the authorization of the individual and the corresponding production of the authentication signal.

The provision of a secure memory 40 in the device allows the device to be personalized without compromising the security or integrity of any software programs, registration or access information stored on the memory 40. Restricted access information may be stored in the secure memory 40. The secure nature of the memory 40 prevents users of the device and/or hackers from altering important identification information such as access codes and biometric profiles registered and stored in the device. Updateable information that may be altered by the user or the processor may also be stored in the secure memory 40 using the audit engine 38. This updateable information may include user information such as an authentication log that records the time and nature of each authorization and/or authentication performed by the card. The audit engine 38 allows an authorized and identified user or manager to access and audit the authentications performed by the device and the time they were performed by entering a password. The authentication log can be scrutinized when desired to monitor the actions of the device user or the attempted use of the device by an unauthorized user.

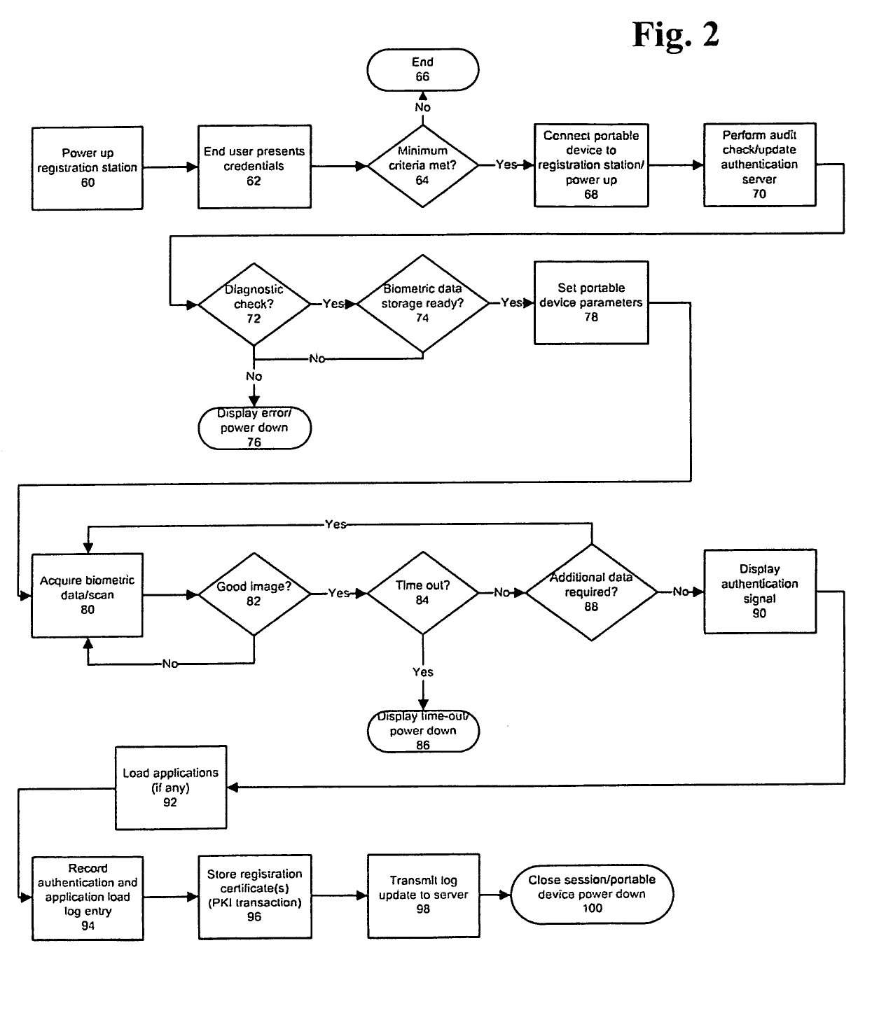

Referring now to FIG. 2, a flow chart of an embodiment of the present invention utilizing a preferred registration routine is shown. The registration process begins with the powering up of a registration station in block 60, by an authorized user (enroller) with credentials in the form of a portable device constructed in accordance with the present invention. Thus, use of the registration station is limited to a predefined set of users holding valid access credentials. Once the registration station is on-line and has access to the necessary certificate authority and certificate information, the person to be enrolled presents his or her credentials and documents required by the policy or regulations of the enrolling authority to the enroller at the registration station in block 62. In block 64, the credentials are examined to determine whether they meet certain minimum criteria. If these minimum criteria are not satisfied, the method proceeds to block 66 where it ends. However, if these minimum criteria are satisfied, the method proceeds to block 68 wherein the portable device is powered up and an authorized communication channel between the portable device and registration station is established. In block 70, the information contained in the portable device is forwarded by the registration station to an authentication server for validation. The method then proceeds to block 72 wherein a diagnostic check of the portable device's electronics systems is performed. If the diagnostic test is passed, the portable device is interrogated to determine if its biometric data storage is ready to be used in an identification process as shown in block 74. If the portable device fails either the diagnostic test or the biometric data check, the method proceeds to block 76 wherein an error message is displayed to a user of the portable device and the portable device is powered down.

If the portable device is functional, the registration station sets a series of parameters in block 78. These parameters instruct the portable device to obtain and provide the appropriate authentication information to the registration system. For example, if fingerprint authorization is required, the parameters instruct the portable device to authenticate the individual's fingerprint. Alternatively, if voice print identification is required, the parameters may instruct the portable device to authenticate the individual's voice received from a microphone mounted on the portable device. Once the parameters are set, the portable device acquires biometric data from the cardholder, such as by scanning the cardholder's fingerprint as shown in block 80. In block 82, the quality of the scanned image is evaluated. If the image is invalid, the method proceeds back to block 80 wherein a new image is scanned. In block 84, a time out condition is evaluated whereby the scanned biometric information is invalidated if a given amount of time has expired. As previously discussed, this time out feature prevents a stolen device from being utilized anytime except immediately after validation. If the time out condition is satisfied, the method proceeds to block 86 wherein the portable device powers down. If the time out condition is not satisfied, a processor in the portable device determines whether additional information is required in block 88. If more information is needed, the method proceeds back to block 80 wherein the additional information is acquired. If sufficient information has been acquired to identify the individual, the method proceeds to block 90 wherein an authentication signal is displayed and communicated to the registration station.

Once the user of the portable device has been authenticated, the authorized application is loaded or prepared as shown in block 92. The user then performs the desired transaction or calls the desired number depending upon the particular application used. The authentication and applications logs are updated in accordance with the actions of the portable device holder in block 94. In block 96, any registration certificates that are used to establish the validity of the initial registered and stored biometric information, or are created as a result of the particular application such as a personal key identified PKI transaction, are stored on the portable device in its internal memory. In block 98, an updated log is sent to the server that is monitoring the use of the portable device. Finally, the registration process terminates in block 100 with the closing of the session and the powering down of the portable device.

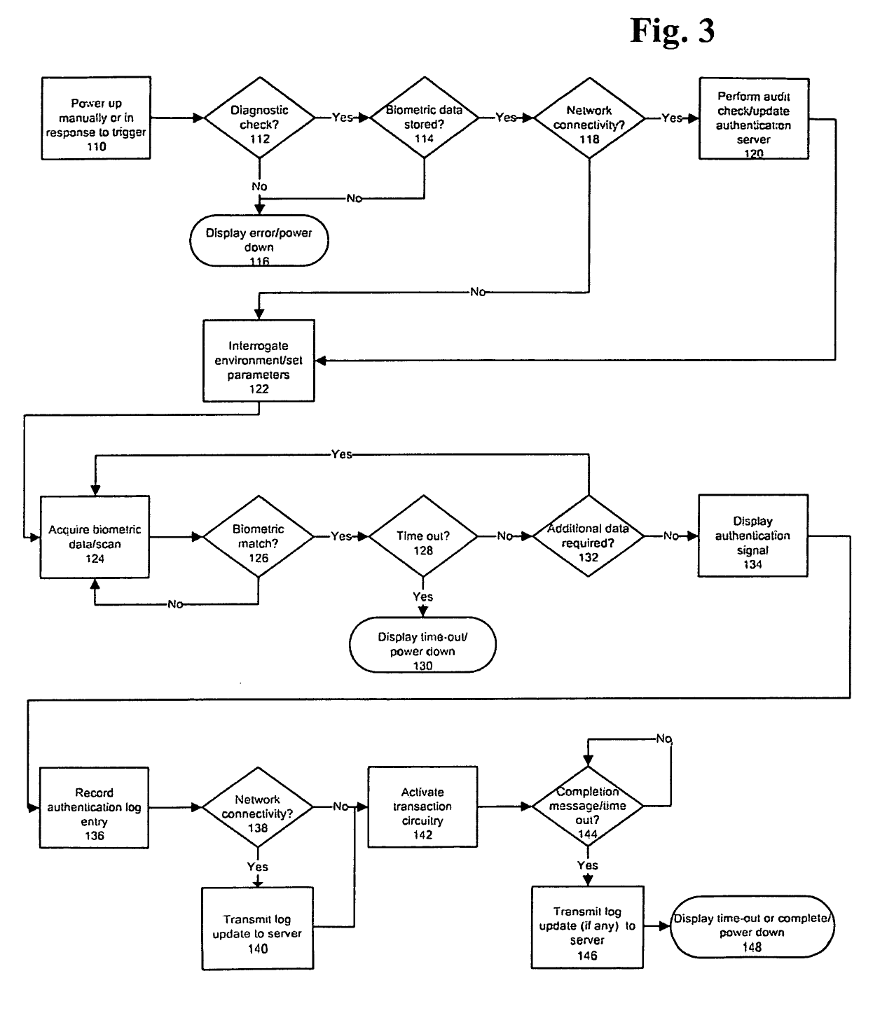

A preferred authentication process for an embodiment of the present invention is set forth in FIG. 3. The authentication process begins in block 110 with the powering up of the portable device in response to an external or programmed trigger or a manual request. After power up, a diagnostic test is performed on the device to insure that all of its systems are functioning properly as set forth in block 112. If the diagnostic test fails in block 112, the process proceeds to block 116 wherein an error message is displayed and the card is powered down. Otherwise, the method proceeds to block 114 to determine if biometric data for making an identification is registered and stored in the device. If not, the process loops back to block 116 wherein an error message is displayed and the card powers down. If biometric identification information is present, the portable device determines whether a communication link has been established with a network in block 118. If a network connection is established, an audit is performed to check and update the server and insure that any necessary accounts are active in block 120. If the device is not connected to a network or the device has passed the network audit, the method proceeds to block 122 wherein the device interrogates its environment to determine if any inputs need to be received and to set the appropriate parameters for receiving the inputs. After all parameters have been set, the preferred authentication method acquires biometric data from a scan or other such input in block 124. If the biometric data matches the biometric data registered and stored in its memory, the method proceeds from block 126 to block 128 wherein a time out condition is monitored. If the biometric data is not a match, the method returns to block 124 wherein it attempts to acquire more biometric information. The method terminates by displaying a time out message and powering down if the time out condition is satisfied as set forth in block 130. Once the biometric information has been received, the authentication routine deter mines if any additional information is required as set forth in block 132. If additional data is required, the method proceeds back to block 134 wherein the device attempts to acquire the additional needed data. If additional data is not required, the method proceeds to block 134 wherein an authentication signal is displayed to the user and/or communicated to a remote device (source). In block 136, an authentication log is recorded and updated to reflect the latest actions of the device holder. If a communication channel is present between the device and a network in block 138, a log update is transmitted to the server as shown in block 140. If there is no network connection, the method proceeds to block 142 wherein transaction circuitry in the device is activated to perform the desired transaction. After the transaction has been completed, a transaction completion message is displayed and the time out condition is reviewed as set forth in block 144. Once the time out condition or transaction complete condition is satisfied, the method proceeds to block 146 wherein a final log update is sent to the server if possible. The method ends in block 148 with the displaying of a transaction complete and/or power off message as the portable device powers down.

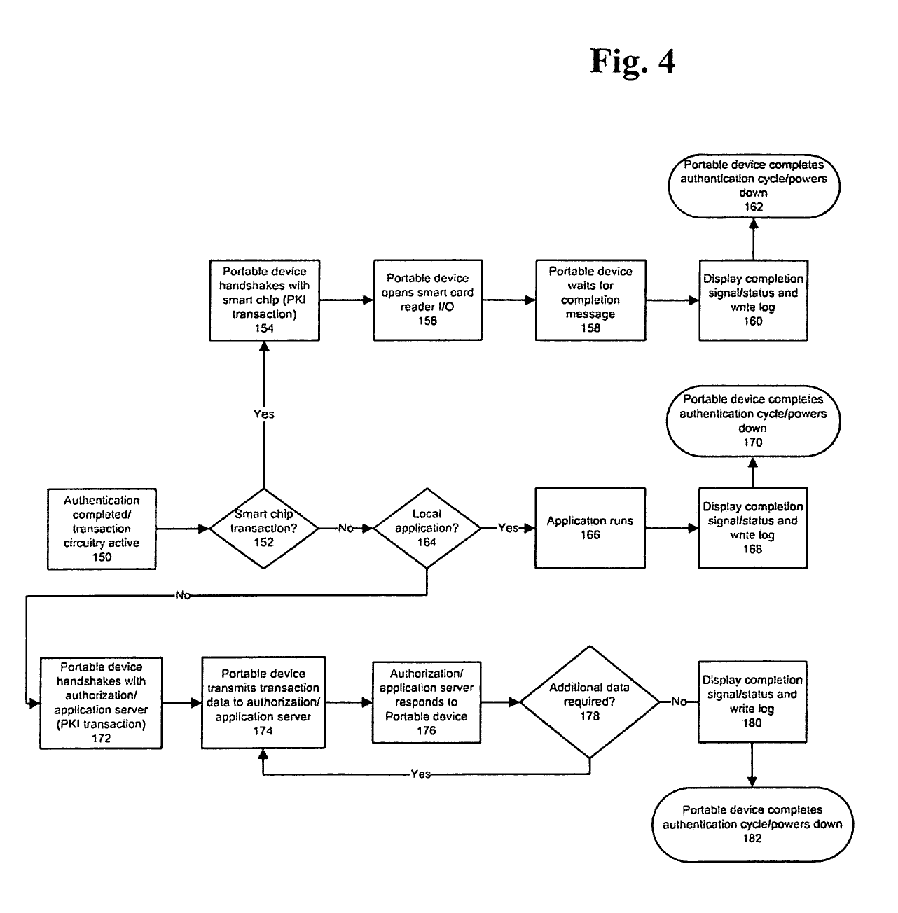

A more detailed description of the transactional processes performed by the self-authenticating, portable device is set forth in FIG. 4. The transactional process begins when the authentication process has been finished and the transactional circuitry is activated as set forth in block 150. Once the transactional process has been initiated, the device evaluates whether or not the desired transaction is a smart chip transaction in block 152. If the transaction is a smart chip transaction, the method proceeds to block 154 wherein the portable device performs established smart chip handshakes with the detected smart chip. The portable device opens its smart card reader input/output in block 156 to allow it to send messages to, and receive messages from, the detected smart chip. In block 158, the portable device waits until all desired messages have been sent to or received from the smart chip. Once the transaction is completed, a completion message is displayed and the transaction is recorded in a writable log in block 160. Finally, the portable device powers down upon completion of the transaction as shown in 162.

If, in block 152, it is determined that the portable device is not involved in a transaction with another smart chip, the portable device determines in block 164 whether the requested transaction is a local transaction performed by the portable device. If it is a local transaction, the portable device runs the requested application in block 166. The ability of the portable device to perform local applications is a significant benefit over the prior art that is accomplished through the provision of a local processor and memory in an identifying device. Such an application could be a calculator, video game or scheduling transaction performed on the portable device. In such a transaction, the portable device would function in a manner similar to a personal data assistant, and PDA, and smart phone. In addition, the on-device authentication capability of the embodiment insures that access to these local applications can be limited to particular individuals and the appropriate associated accounts debited or credited accordingly. Once the application has run, a completion message is displayed and the status log updated in block 168. The portable device completes the authentication cycle and powers down in block 170.

If, in block 164, it is determined that a local transaction is not involved, the method proceeds to block 172 wherein the portable device exchanges handshake signals useful in performing a personal key identification transaction with the detected authorization/application server. After a communication channel with the remote application is established, the portable device transmits transactional data to the authorization/application server as set forth in block 174. In block 176, the application/authorization server responds to the portable device. If the response indicates that the application authorization server needs additional data from the portable device as set forth in block 178, the method loops back to block 174 wherein the portable device sends the additional requested data to the server. If no additional data is needed, a completion signal is displayed and the status and write logs are updated in block 180. The portable device completes the authentication cycle and powers down in block 182.

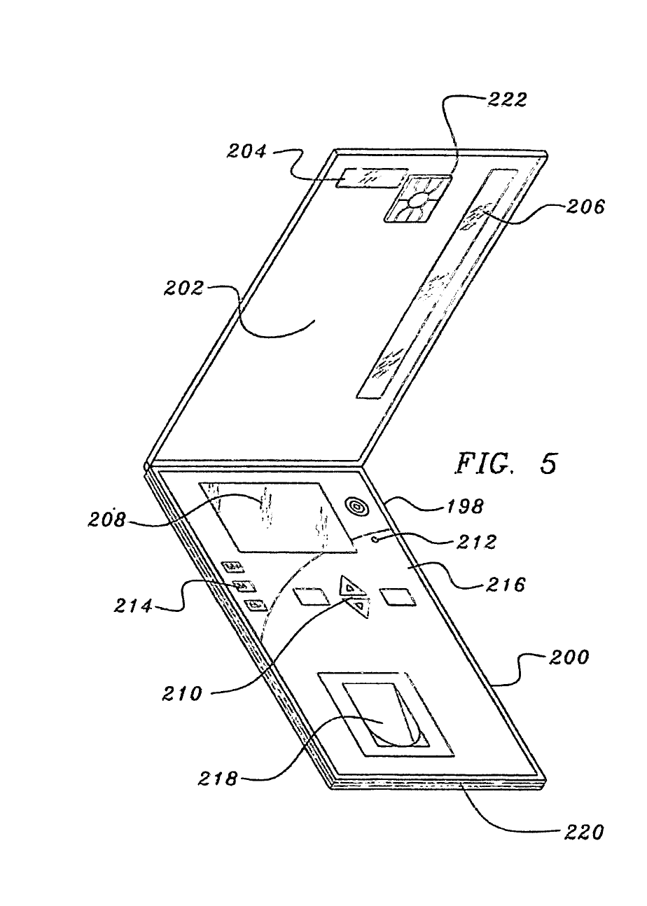

FIG. 5 is a pictorial representation of a preferred external configuration for an embodiment of the present invention. The embodiment consists of an electronics housing 200 rotatably attached to a flip cover 202. The provision of the electronics housing 200 allows the embodiment to contain all of the electronic components 220 necessary to support voice and fingerprint identification software and interfaces. These electronic components 220 preferably include a rechargeable battery, power supply, processor, secure memory, etc. as set forth in more detail above. A power switch 198 and associated indicator light are provided on the housing 200. The flip cover 202 preferably contains an embedded proximity communication antenna (not shown) and two magnetic stripe emulators 204 and 206. The magnetic stripe emulator 204 positioned on the far end of the flip cover 202 is designed to be used with “swipe” type card readers while the magnetic stripe emulator 206 positioned on the side of the flip cover is designed to be used with “dip” type card readers. The provision of the magnetic stripe emulators 204 and 206 and the internal proximity antenna in the flip cover 202 allows the device to communicate with preexisting proximity or magnetic stripe type card readers that are currently used with a wide range of applications. A LCD display 208 is provided on the electronics housing 200 that allows the embodiment to communicate with a user. The display 208 preferably is capable of displaying text messages as well as color and black-and-white video images. Menu navigation and selection buttons 210 are provided that allow an individual to communicate instructions to the embodiment. Appropriate menus may be provided that allow the user to input text through the buttons 210. In a most preferred embodiment, a microphone/speaker 212 is utilized in conjunction with voice recognition software to allow the device to respond to voice commands from a user and convert spoken messages by the user into text files. This voice recognition software is also utilized to perform a voice identification process to authenticate individuals for various applications as discussed in more detail above. Indicator lights 214 are used to display common outputs such as “transaction completed” or “identity authenticated”.

A variety of communication devices are incorporated into the electronic housing 200 and flip cover 202. More particularly, USB and power input connectors 216 are provided on the side of the electronic housing 200 that allow the device to establish communications with other devices such as printers, PDAs and personal computers that have this capability. A proximity antenna is incorporated into the flip cover 202 such that messages may be sent to, and received, from proximity type devices utilized in applications such as parking garages and security systems. A set of smart card contacts 222 allow the device to communicate using the smart card format. The on-board power supply and processing capability of the embodiment allow the information dynamically coded on the magnetic stripe emulators 204 and 206 to be altered as desired by the device holder or the device itself with proper authorization. Registration certificates loaded on the stripe emulators 204 and 206 or in read-only memory that is incorporated into the device's electronics can be monitored by the device's processor to insure that access to any restricted data saved in the device's memory or encoded on the stripe emulators 204 and 206 is limited such that the data is not altered by unauthorized individuals.

A fingerprint sensor 218 is provided on the electronics housing 200 to receive biometric information from an individual possessing the device. Although a fingerprint sensor 218 is shown on the embodiment of FIG. 5 in alternative embodiments the fingerprint sensor 218 could be replaced with or supplemented by a camera capable of facial scanning, iris scanning, retinal scanning and a DNA sensor. The fingerprint sensor 218 is used to obtain biometric data that is compared to a reference database stored in the device's memory. Storing the reference data in the device itself limits access to the data and eliminates the need for centralized databases.

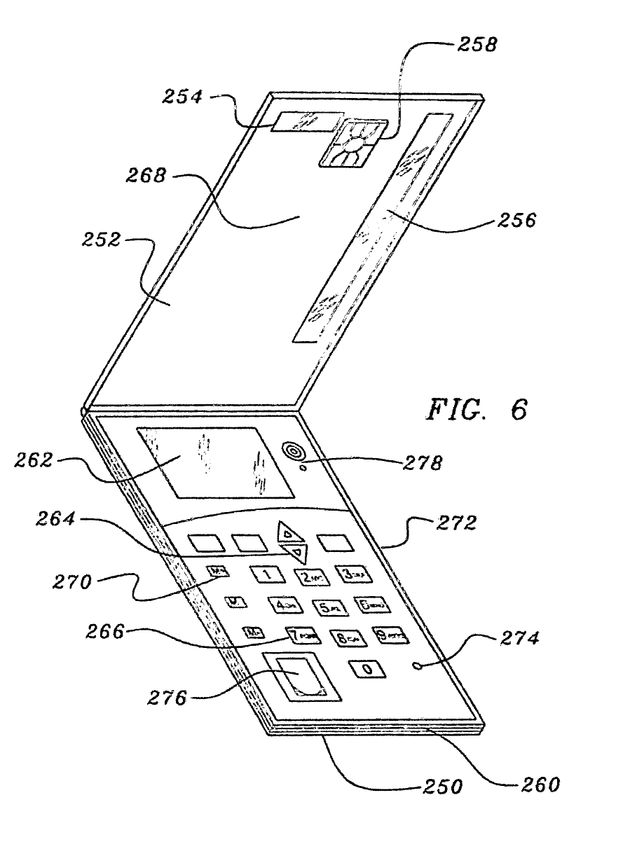

Yet another preferred embodiment of an external configuration of a device constructed in accordance with the present invention is set forth in FIG. 6. The device includes a housing 250 attached to a flip cover 252. The flip cover 252 has a magnetic stripe emulator 254 for swipe type applications and a magnetic stripe emulator 256 for dip type applications. A set of smart card contacts 258 are also provided on the flip cover 252. A proximity antenna is embedded in the flip top cover 252 (or, alternatively, one or more antennae within the housing 250) that allow(s) the device to communicate with other radio frequency equipped devices. The housing 250 contains the electronics 260 needed to operate the device. A camera 268 allows the device to create digital data that corresponds to visual biometric information such as facial features, iris scans and retinal scans. A USB port 272 is provided on the housing 250 such that the device can communicate data to devices operating in accordance with the USB protocol. The numerous input/output ports utilized by the device enable the device to communicate with one or more other devices to send and receive secure data, configuration information and commands as well as transmit proof of the user's authentication. This capability can be used effectively in dual-key/multi-key access or activation of equipment, such as military fire-control, as well as providing proof of several users' participation in assembling and/or securely transmitting information, such as patient and insurance coverage identification and the presentation of electronic prescriptions “signed” by the physician in healthcare applications. The ability of the device to communicate with a wide variety of different types of devices using a variety of different formats represent a significant advancement over the prior art.

A speaker/microphone 274 is provided on the housing that allows the device to send and receive audible information. The microphone/speaker 274 allows the device to provide identity authentication by means of a voice match. In addition, the device can respond to voice commands with a basic natural vocabulary that the user can expand by training the device with each command before and during use. This provides a significant and flexible alternative for user input and data entry, especially for users with certain disabilities. A fingerprint sensor 276 is provided such that fingerprint identifications can be performed by the device as discussed in more detail above. A display 262 mounted on the housing 250 is used to display information to a user of the device. Status and indicator lights 270 provide a user with visual indications of commonly performed operations. A set of menu navigation keys 264 and an alphanumeric keypad 266 in conjunction with the display 262 and indicator lights 270 further facilitate communicate between a user and the device. A power switch 278 is used to turn the device on and off. The raised symbology embossed on the keypad 266 aids the use of the device by persons with certain disabilities and under conditions of reduced visibility.

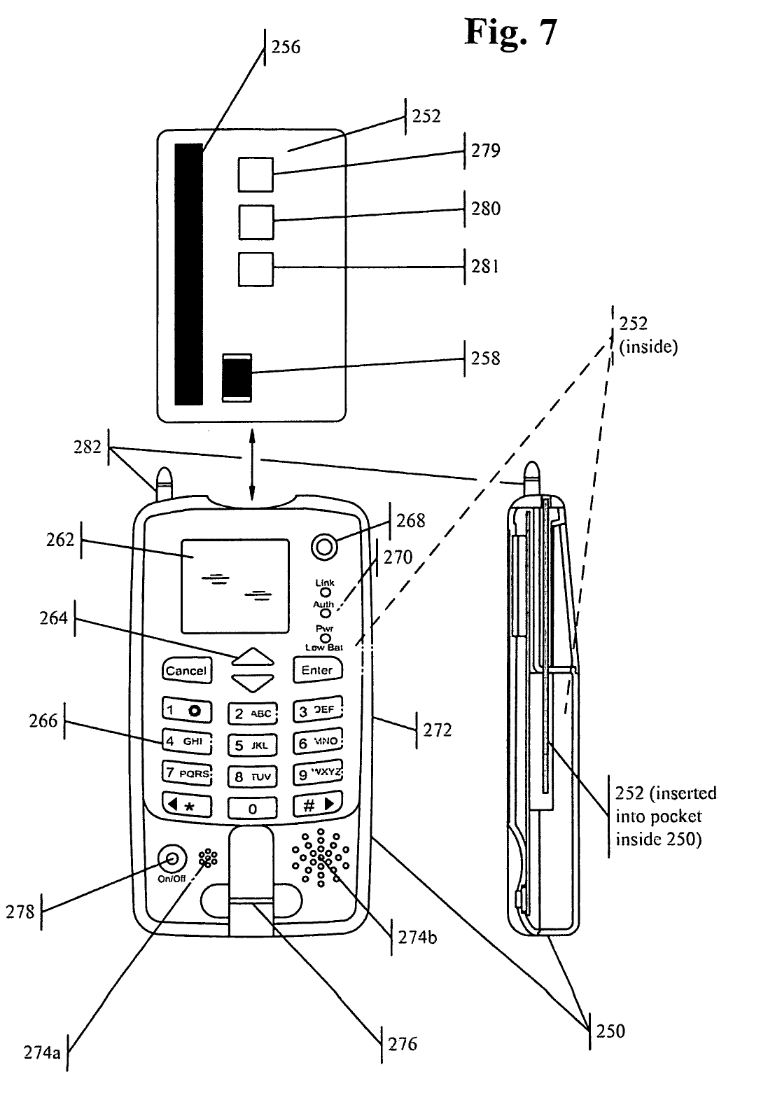

An embodiment of an external configuration of a device constructed in accordance with the present invention is set forth in FIG. 7. The device includes a housing 250 incorporating a slot for a removable card 268. The removable card 252 has power source 279, a processor 280, memory 281 and a magnetic stripe emulator 256. A set of smart card contacts 258 are also provided on the removable card 252. One or more antenna(e) is (are) embedded in the housing 250 that allow(s) the device to communicate with other radio frequency equipped devices, including an antenna for cellular phone communications 282. A camera 268 allows the device to create digital data that corresponds to visual biometric information such as facial features, iris scans and retinal scans. The housing 250 contains the electronics 260 needed to operate the device. A USB port 272 is provided on the housing 250 such that the device can communicate data to devices operating in accordance with the USB protocol. The numerous input/output ports utilized by the device enable the device to communicate with one or more other devices to send and receive secure data, configuration information and commands as well as transmit proof of the user's authentication. This capability can be used effectively in dual-key/multi-key access or activation of equipment, such as military fire-control, as well as providing proof of several users' participation in assembling and/or securely transmitting information, such as patient and insurance coverage identification and the presentation of electronic prescriptions “signed” by the physician in healthcare applications. The ability of the device to communicate with a wide variety of different types of devices using a variety of different formats represent a significant advancement over the prior art.

A microphone 274a and speaker 274b are provided on the housing that allows the device to send and receive audible information. The microphone 274a and speaker 274b allow the device to provide identity authentication by means of a voice match. In addition, the device can respond to voice commands with a basic natural vocabulary that the user can expand by training the device with each command before and during use. This provides a significant and flexible alternative for user input and data entry, especially for users with certain disabilities. A fingerprint sensor 276 is provided such that fingerprint identifications can be performed by the device as discussed in more detail above. A display 262 mounted on the housing 250 is used to display information to a user of the device. The display 262 is of a size and capability to present photos and other information to identify the user and, in addition, to display other information such as operating instructions and personal or organizational data and emblems. Status and indicator lights 270 provide a user with visual indications of commonly performed operations. A set of menu navigation keys 264 and an alphanumeric keypad 266 in conjunction with the display 262 and indicator lights 270 further facilitate communicate between a user and the device. A power switch 278 is used to turn the device on and off.

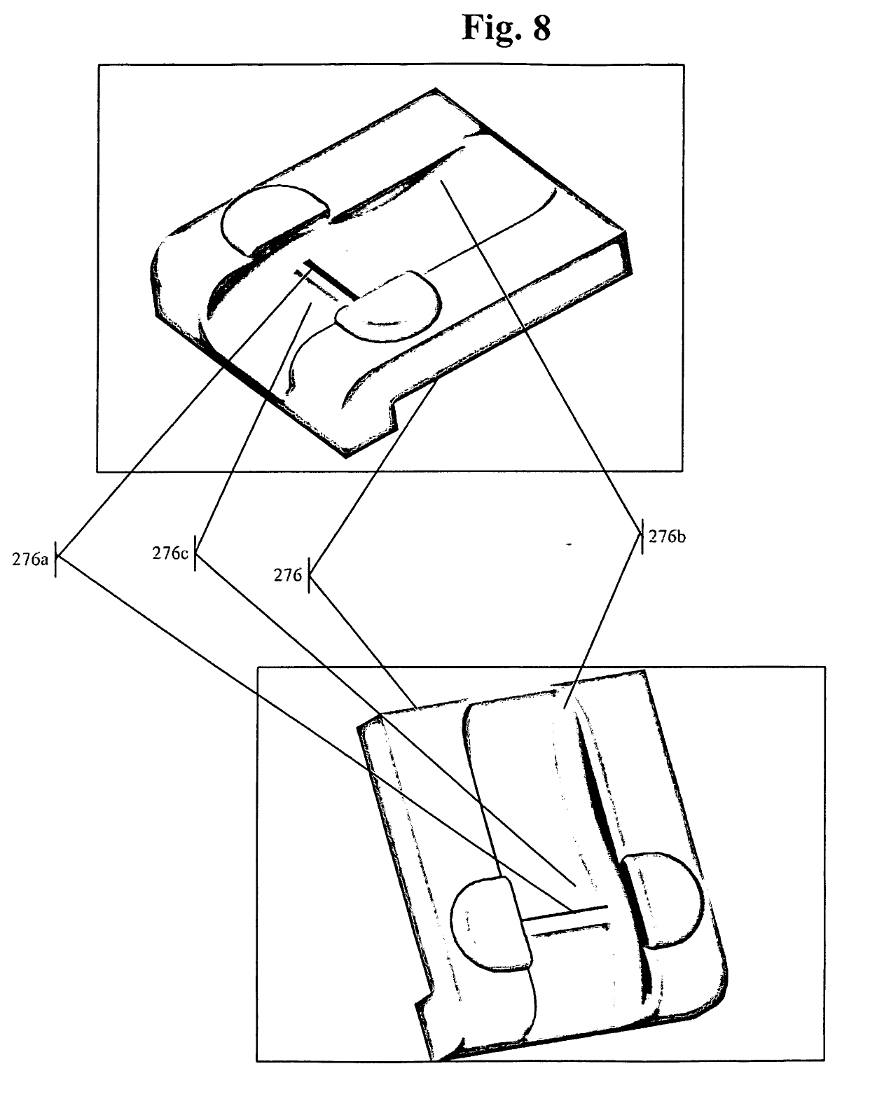

FIG. 8 is a pictorial representation of a preferred swipe fingerprint sensor housing configuration for an embodiment of the present invention. The embodiment consists of wide groove 276b combined with a raised hump 276c that guides the finger over the fingerprint sensor 276a, such that the finger is kept in position as it is swiped and the housing configuration provides tactile feedback to the user as the finger rolls over the fingerprint sensor 276a so that the finger is applied with optimum pressure to allow for capture of a clean and detailed fingerprint image.

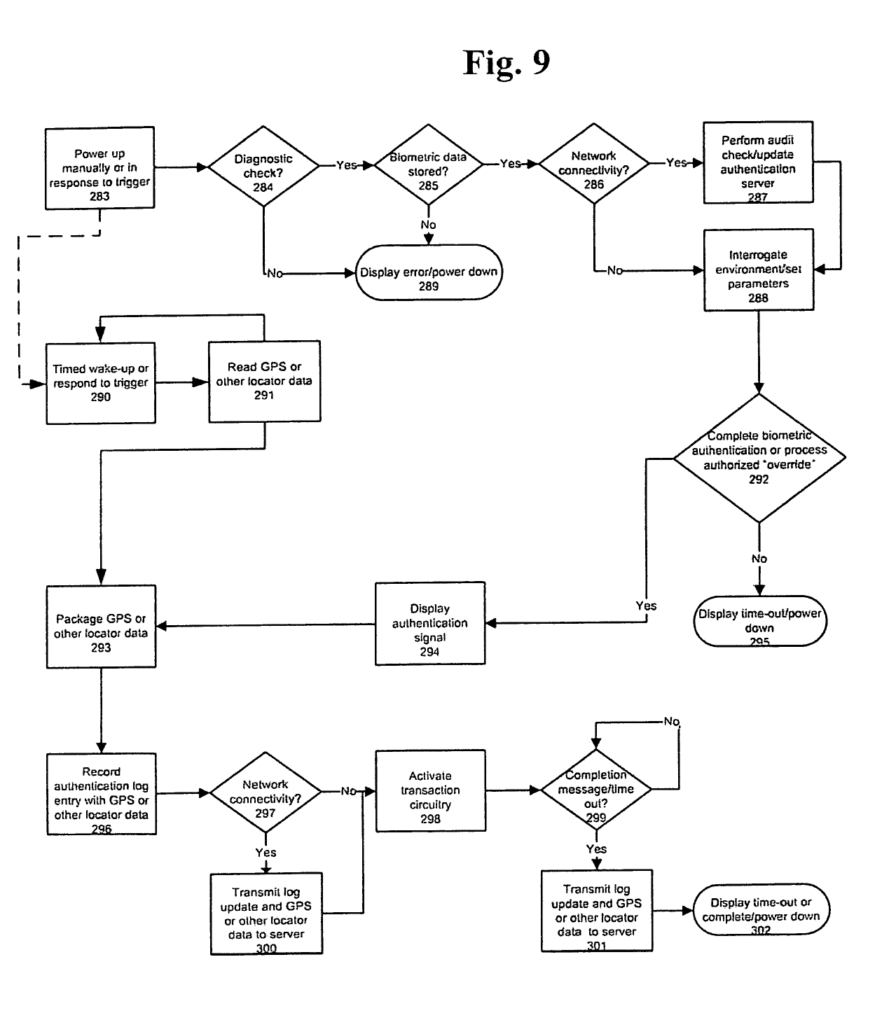

A preferred locator process for an embodiment of the present invention is set forth in FIG. 9. The location process beings in block 290, wherein with a powering up of the portable device in response to an external or programmed trigger. After power up, The portable device reads its location from the Global Positioning System (GPS) circuitry in step 291, or uses other locator technology to establish either its absolute geographic or relative position. For example, within a building equipped with radio, infrared or other transponders that can establish the position of the device within the covered area. Updates to location proceed in an iterative fashion following a programmed schedule or upon other trigger conditions. The authentication process begins in block 283 with the powering up of the portable device in response to an external or programmed trigger or a manual request. After power up, a diagnostic test is performed on the device to insure that all of its systems are functioning properly as set forth in block 284. If the diagnostic test fails in block 284, the process proceeds to block 289 wherein an error message is displayed and the card is powered down. Otherwise, the method proceeds to block 285 to determine if biometric data for making an identification is registered and stored in the device. If not, the process loops back to block 289 wherein an error message is displayed and the card powers down. If biometric identification information is present, the card determines whether a communication link has been established with a network in block 286. If a network connection is established, an audit is performed to check and update the server and insure that any necessary accounts are active in block 287. If the device is not connected to a network or the device has passed the network audit, the method proceeds to block 288 wherein the device interrogates its environment to determine if any inputs need to be received and to set the appropriate parameters for receiving the inputs. After all parameters have been set, the preferred authentication method acquires biometric data from a scan or other such input in block 292. If the biometric data is not a match, the method ends at block 295 where it terminates by displaying a time out message and powering down. Once the biometric authentication routine successfully completes, the method proceeds to block 294 wherein an authentication signal is displayed to the user and/or communicated to a remote device (source). In block 293, the GPS or other locator data is retrieved and prepared for transmission. In block 296, an authentication log and locator data are recorded and updated to reflect the authentication and geographic position of the device holder. If a communication channel is present between the device and a network in block 297, a log update is transmitted to the server as shown in block 300. If there is no network connection the method proceeds to block 298 wherein transaction circuitry in the device is activated to perform the desired transaction. After the transaction has been completed a transaction completion message is displayed and the time out condition is reviewed as set forth in block 299. Once the time out condition or transaction complete condition is satisfied, the method proceeds to block 301 wherein a final log update is sent to the server if possible. The method ends in block 302 with the displaying of a transaction complete and/or power off message as the portable device powers down.

In addition to the above-discussed features, the present invention disclosure also includes the subject matter contained in the appended claims. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

I claim:

1. A portable device for registering and storing entirely within the device one or more biometric profiles consisting of biometric samples scanned by one or more biometric sensors, and authenticating an individual's identity by comparison of a scanned sample to one or more of the registered and stored profiles, validating a prospective remote source communicating with said portable device, securing any information stored in and communicated between said portable device and the remote source as a prospective receiver, securing said device against tampering or counterfeiting, and authorizing use of limited access accounts, applications or services; said portable device comprising:
one or more biometric sensors for detecting biometric information and producing a sensed biometric profile;
a processor for comparing the sensed biometric profile with at least one of the registered and stored biometric profiles and producing an authentication signal as well as supporting other processing activities of the device;
a memory for storing data relating to said biometric profiles;
disabling software that attempts to detect tampering with the device and disables the device if tampering is detected;
a keypad that allow a user of the portable device to enter information and select device configurations and commands;
at least one input communication means for receiving a request, information or command from a remote source;
at least one output communication means for sending a request, information or command to a remote source by generating a magnetic output that emulates a magnetic stripe that is readable by a standard swipe card reader and is permanently attached to the portable electronic device; and
a smart chip that is readable by a standard smart card reader.

2. The portable device of claim 1 further comprising a radio frequency antenna or antennae for sending messages to, and receiving messages from, another radio frequency antenna on a remote device.

3. The portable device of claim 1 further comprising a microphone for receiving audible signals and voice recognition software for comparing said audible signals to registered and stored individual voice profiles.

4. The portable device of claim 1 further comprising a speaker and software that allows the processor to produce voice responses.

5. The portable device of claim 1 wherein said memory contains an encryption algorithm that generates certification information that can be exchanged with a remote source to determine if the device is authentic: to verify that the disabling software has not detected an attempt to tamper with the device and to decrypt and validate certification information from the remote source to determine if the remote source is legitimate.

6. The portable device of claim 1 wherein the at least one output communication means further comprises a protrusion permanently attached thereto that is adapted to engage a magnetic swipe card reader and a smart card reader.

7. The portable device of claim 1 wherein said biometric sensor further comprises a fingerprint sensor having a housing that guides a user's finger over the fingerprint sensor and provides tactile feedback to the user.

8. The portable device of claim 1 further comprising software that enables public key infrastructure transactions that include certification information that can be examined by a remote source to determine if the device corresponds to an authorized account.

9. The portable device of claim 1 further comprising a docking slot and a removable card equipped with a power source, processor, memory and programmable magnetic stripe that receives information from the device after authentication and is adapted to engage a magnetic swipe card reader wherein the removable card returns to a blank state after a set period of time has passed since the removable card has received information from the portable device.

10. The portable device of claim 1 wherein said device performs an initial verification of a user's identity prior to establishing communication with or transmitting any data to an external device other than a server associated with the portable device.

11. The portable device of claim 1 wherein said portable device has a control code that can be transmitted to a remote device to enable said portable device to control said remote device.

12. The portable device of claim 1 further comprising a cellular telephone.

13. The portable device of claim 1 wherein the portable device incorporates global positioning system (GPS) circuitry to provide information on geographic location.

14. A method of authorizing an individual to access an account or perform a transaction with a portable electronic device having a magnetic strip card interface permanently attached thereto, said method comprising:
detecting a communication center's request for an identification and information;
verifying that the communication center and its request are legitimate;
receiving configuration information from the communication center;
configuring the portable device according to the received configuration information;
prompting an individual to respond to said request for an identification and information by providing biometric information to said portable electronic device;
receiving said biometric information from said user;
processing said biometric information to determine if said biometric information corresponds to a biometric profile registered and stored on said portable electronic device;
allowing the user to enter information and select commands and options from the included keypad;
producing an authentication signal and/or message;
encrypting the authentication message; and
communicating said authentication signal and/or authentication and/or informational message to said communication center in response to receiving said request for an identification and information through said magnetic card swipe interface.

15. The method of claim 14 wherein the step of receiving biometric information from said user further comprises receiving a representation of at least two of said user's fingerprints in a specific sequence.

16. The method of claim 14 wherein a number of points of comparison are used to compare the biometric information and the biometric profile and the number of points of comparison is determined based upon information received from an authorized external source.

17. The method of claim 14 further comprising monitoring user entered information to determine if a user is acting under duress and preventing said user from accesses said account if it is determined that said user is acting under address.

18. The method of claim 14 further comprising the step of storing at least one of a private key and a public key.

19. The method of claim 14 wherein profiles from a plurality of users are registered, stored and authenticated on the device to provide dual-key or multiple-key authorizations for defined transactions.

20. The method of claim 14 further comprising the step of determining a location of the user and transmitting said location to said communication center.
